(19) United States
(12) Patent Application Publication
(10) Pub. No.: US 2010/0084444 A1
(43) Pub. Date: Apr. 8, 2010

(54) Lightweight Sitting Stretcher

(76) Inventors: Avraham Yancovitch, Rehovot (IL); David Daboush, Tel Aviv (IL)

Correspondence Address: The Law Office of Michael E. Kondoudis, 888 16th Street, N.W., Suite 800, Washington, DC, 20006, US

(21) Appl. No.: 12/303,172

(22) PCT Filed: Jun. 7, 2007
(86) PCT No.: PCT/IL07/00691

§ 371 Date: Oct. 12, 2009

(30) Foreign Application Priority Data
Jun. 8, 2006 (IL) 176218

(51) Int. Cl. A61G 1/00

(52) U.S. Cl. 224/158

(57) ABSTRACT

A portable stretcher is provided so that two persons can manually transport an injured person in a seated position. The stretcher is made of a harness where the injured person can sit upon and two carrying straps for the two people transporting the injured person. The harness includes means for securing the injured person so that he cannot slip from the harness during the transport and further hurt himself.

### FIELD OF THE INVENTION

The present invention relates to means for carrying injured people and more particularly to stretchers for carrying an injured person in a sitting/leaning position by while leaving the hands of the carrying people free.

### BACKGROUND OF THE INVENTION

An injured person in the field or inside a building often needs to first be evacuated primarily to a more accessible location before further help can be administered. For example, injured people can be brought to a road where a car or an ambulance can take them to a hospital or where medical staff can give them a first medical treatment.

An injured person that is unable to walk is evacuated today by two methods. The first evacuation method consists of transporting the injured person in a stretcher, where the injured person is carried lying in a horizontal position. The stretcher is typically carried by four people, but can also be carried by two people if necessary.

The second evacuation method consists of using improvised means such as carrying the injured person on one's shoulder, carrying the injured person by two people by supporting the injured person's shoulder, carrying the injured person by two people crossing their hands and letting the injured person sit on their crossed, four hands or by using any other improvised mean.

In cases where a group of people such as hikers or soldiers prepare to go into the field, or into an area that is not easily accessible, a portable stretcher can be brought by the group. Such a portable stretcher weighs sometimes between 7 and 12 KG or even more. In many cases, groups go into the field without a portable stretcher due to the inconvenience caused by the weight and size of a portable stretcher.

A stretcher is very convenient to use in an open area or an area that is easy to maneuver. However, a stretcher might not fit into a small elevator, or might be very hard to maneuver in narrow or curving places.

In many circumstances it is desired that the people carrying the injured person remain with free use of their hands. From example, going down a rough terrain or going down steep flights of stairs especially when carrying a third person may be dangerous without using the hands. The same is true for dark locations where one would like to use his hand for orientation or a soldier that would need to use a weapon or an instrument during the evacuation. In such occasions, a lightweight stretcher that allows carrying an injured person without mobilizing one's hand would prove very useful.

Portable stretchers are known in the art. U.S. Pat. No. 5,466,040 discloses a high rise evacuation chair such that the persons carrying the stretcher maintain the use of their hands. U.S. Pat. No. 5,466,040 however requires the use of two rigid bars for support thus making the stretcher less flexible for maneuvers, and less convenient to be carried by travelers or soldiers when not in use.

Travelers and soldiers frequently carry a first aid kit with them so that basic medical treatment can be administered quickly to an injured person. A stretcher is not always carried by groups of travelers or soldiers due to the size, weight and even price of a portable stretcher. It would be desirable to have a lightweight stretcher that can be packed conveniently, so that travelers and soldiers can carry it with a minimal effort.

### SUMMARY OF THE INVENTION

It is an object of the present invention to provide a portable stretcher so that two persons can manually transport an injured person in a seated position.

The invention enables two people to transport an injured person that is able to be carried in a sitting position. When in the field or inside a building, an injured person frequently needs to be transported to a point where medical help is available, or to a point where further transportation is available.

The present invention relates to a portable stretcher made of a lightweight material, for manually transporting an injured person in a seated position, said stretcher comprising:
(i) a harness for carrying said injured person in a sitting position;
(ii) means for securing said injured person to said harness;
(iii) two carrying straps, each strap including at least one buckle for adjusting the strap's length; and
(iv) means for attaching said two carrying straps to said harness.

The stretcher is made of a harness where the injured person can sit upon and two carrying straps for the two people transporting the injured person. The harness includes means for securing the injured person so that he cannot slip from the harness during the transport and further hurt himself.

Each carrying straps includes at least one buckle or a similar mechanism for adjusting the size of the carrying strap, depending on the size of the persons carrying the stretcher and the size of the injured person.

### BRIEF DESCRIPTION OF THE DRAWINGS

FIG. 1 shows the light stretcher of the invention from a top-side view.

FIG. 2 illustrates how an injured person is carried on the stretcher of the invention by two people.

FIG. 3 is a side view of an injured person sitting on the stretcher of the invention.

FIGS. 4a-4c illustrate the steps how the stretcher is opened from a folded position and prepared to be used.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

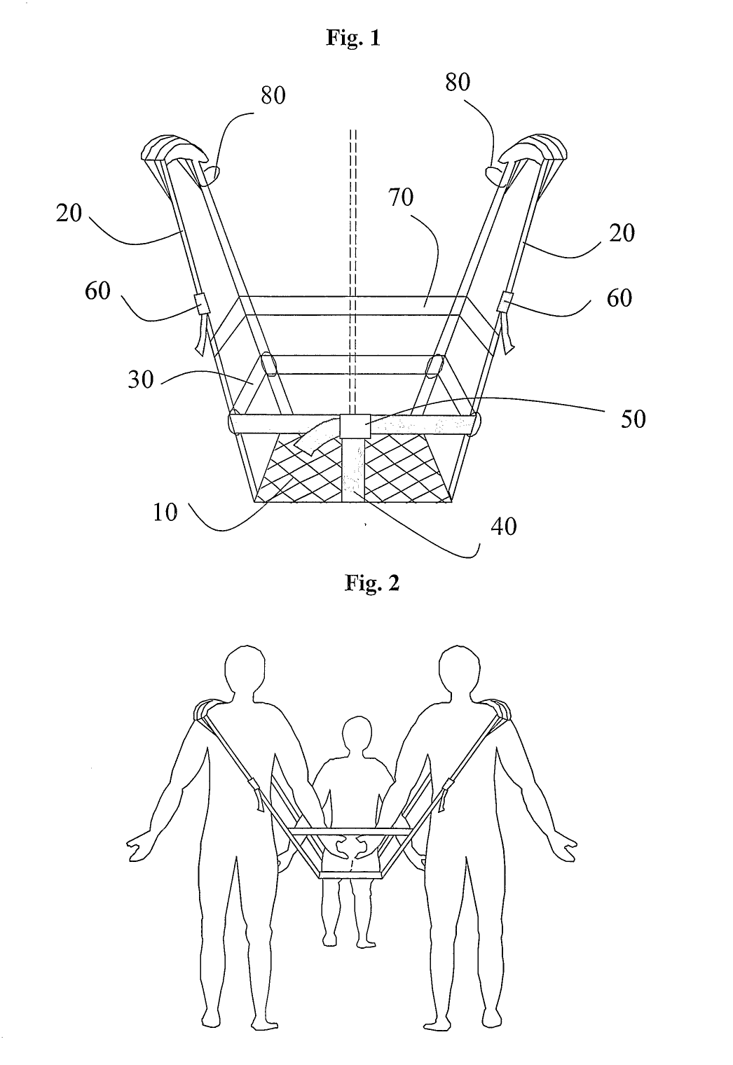

FIG. 1 illustrates the stretcher of the invention shown from a top-side view. The injured person to be transported sits inside the harness 10. On each side of the harness 10 is attached a carrying strap 20. The harness 10 is composed of a bottom portion typically made as a grid upon which the injured person is sifted. The injured person may also sit on a full surface without any holes or spaces.

The harness 10 contains a mechanism to secure the injured person so that the injured person cannot slip off the harness when being transported. One example of such a mechanism to secure the injured person to the harness is shown in FIG. 1. A waist strap 30 surrounds the injured person's waist and thus secures him to the harness 10. Each leg of the injured persons is placed on a different side of the crotch strap 40 so that the injured person cannot slip down from the harness 10. A waist strap buckle 50 allows adjusting the waist strap 30 to the desired size so that the injured person is both secure and comfortable.

Each carrying strap 20 includes at least one buckle 60 or a similar mechanism in order to adjust the size of the carrying strap 20 to best fit the carrying person and the injured person. The carrying strap 20 is placed on the carrying person's shoulder as illustrated in FIG. 2 where the carrying strap 20 is wrapped around the shoulder away from the harness 10. The carrying strap 20 is wrapped around the shoulder and is attached to the harness 10 in two locations.

In one embodiment of the present invention, each carrying strap 20 is fitted with two buckles 60 or similar adjusting mechanisms. One buckle 60 is placed towards the carrying person's front while the other is placed towards the carrying person's back. The particularity and advantage of using two buckles 60 on each strap is that it then becomes possible to adjust the buckle 60 on the back of the carrying person so that the carrying strap 20 is lower on the back side compared to strap on the front side. As a result, the injured person will be carried in a reclining position towards the back, adding to his stability and comfort.

An important advantage of the invention is that the two carrying persons remain with full control of their two hands. Thus the stretcher of the invention can be carried in a rough terrain, in steep stairs, in the dark and other unfavorable conditions while the carrying persons are able to use their hands to stabilize themselves, for examples by holding on to a rail, a wall, a tree or any other available object. Soldiers carrying a wounded person in combat situations are still able to use their weapons while carrying the wounded person with the stretcher of the invention.

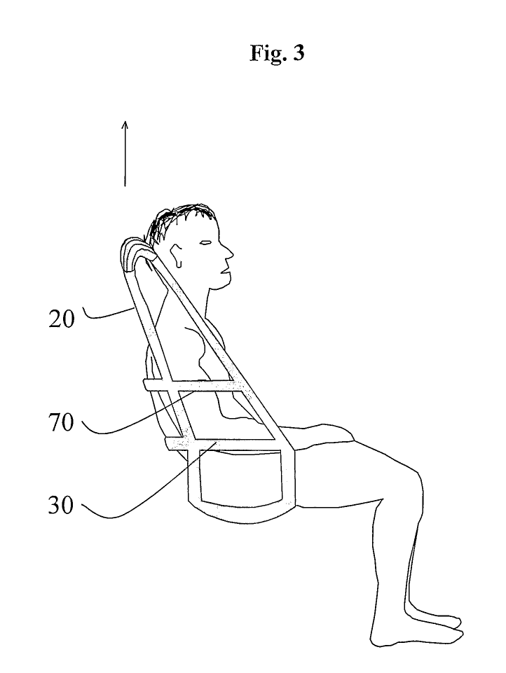

FIG. 3 shows a side view of an injured person sitted in the stretcher of the invention. In yet another embodiment of the present invention, an additional support strap 70 is attached to the two carrying straps 20 as also shown in FIG. 1 so that the additional support strap 70 provides further support to the injured person's back. The support strap 70 is only attached to the back portion of the stretcher.

One advantage of the invention is that the stretcher can be built from lightweight material including but not limited to: cloth, any plastic material including nylon, rope, rubber, any natural or synthetic fiber or any combination thereof.

As a result of the lightweight material used in the stretcher, the stretcher of the invention can be constructed with a lower weight compared to portable stretchers of prior art. In one embodiment of the present invention, the stretcher is made weighing less than 2.5 kg or even less than 1.5 kg.

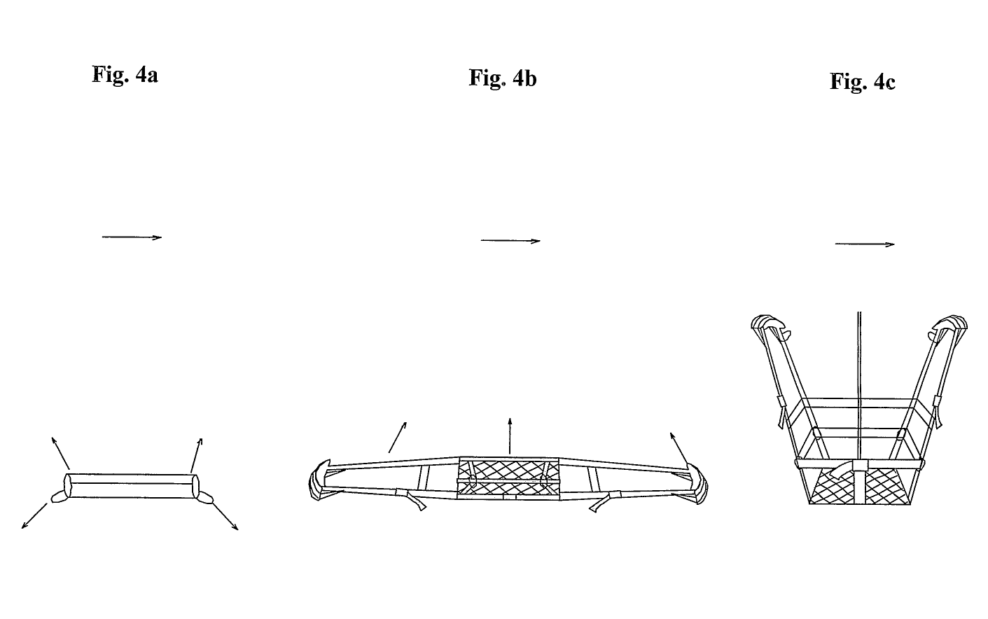

Another advantage of the invention is that since the stretcher is made from lightweight, flexible material, the stretcher can be easily folded to occupy less space when unused. In another embodiment of the present invention, the stretcher includes means to fold the stretcher to a compact case. In yet another embodiment of the present invention, the stretcher contains a quick-release mechanism so that the stretcher can be unfolded by a single operation. FIGS. 4a-4c illustrate the different steps of unfolding the stretcher. FIG. 4a shows the stretcher of the invention in a folded position. The folded position is a compact case that can be stored and carried easily, for example as part of a first-aid kit. In order to unfold the stretcher, it is necessary to pull on the two extreme side of the folded stretcher as shown by the arrows of FIG. 4a. FIG. 4b shows the stretcher after it has been initially unfolded, still in a flat position. Pulling up on the carrying straps 20 and harness 10 brings the stretcher to a full operational position as illustrated in FIG. 4c.

Portable stretchers and stretchers where the injured person is carried in a sitting position have been disclosed in the art. U.S. Pat. No. 5,466,040 disclosed a stretcher that is carried via a harness. However, the stretcher of U.S. Pat. No. 5,466,040 requires the use of two rigid bars for support thus making the stretcher heavier, less flexible for maneuvers, and less convenient to be carried by travelers or soldiers when not in use.

JP 2003038757 discloses a foldable, light stretcher where the wounded person is carried in a sitting position. However, in JP 2003038757 the two persons carrying the stretcher must hold the stretcher with their two hands. The carrying persons must also face each other with the stretcher in between them and thus walk sideways, which is an inconvenient and slow way to walk.

In certain circumstances, it is necessary to evacuate an injured person via the air typically by a helicopter or towards a boat. The stretcher of the invention can include means to transport the stretcher by an aerial transportation mean.

For example, the top part of each carrying strap 20 can contain a clip 80 adapted for being attached a hook lowered by a helicopter or a boat, so that by attaching two hooks to the stretcher's clips 80, the stretcher can be evacuated by an aerial transportation mean or vehicle.

Although the invention has been described in detail, nevertheless changes and modifications, which do not depart from the teachings of the present invention, will be evident to those skilled in the art. Such changes and modifications are deemed to come within the purview of the present invention and the appended claims.

1. A portable stretcher made of a lightweight material, for manually transporting an injured person in a seated position, said stretcher comprising:
(i) a harness for carrying said injured person in a sitting position;
(ii) means for securing said injured person 5 to said harness;
(iii) two carrying straps, each strap including at least one buckle for adjusting the strap's length; and
(iv) means for attaching said two carrying straps to said harness.

2. The stretcher of claim 1, further including an additional support strap attached to said two carrying straps, providing support for the injured person's back.

3. The stretcher according to claim 1, wherein said lightweight material is cloth, any plastic material including nylon, rope, rubber or any combination thereof.

4. The stretcher according to claim 1, weighing less than 1.5 kg.

5. The stretcher according to claim 1, further including means to fold the stretcher to a compact case.

6. The stretcher of claim 5, further including a quick-release mechanism.

7. The stretcher according to claim 1, further including means to transport said stretcher by aerial evacuation means.

8. The stretcher according to claim 2, wherein said lightweight material is cloth, any plastic material including nylon, rope, rubber or any combination thereof.

9. The stretcher according to claim 2, weighing less than 1.5 kg.

10. The stretcher according to claim 3, weighing less than 1.5 kg.

11. The stretcher according to claim 2, further including means to fold the stretcher to a compact case.

12. The stretcher according to claim 3, further including means to fold the stretcher to a compact case.

13. The stretcher according to claim 4, further including means to fold the stretcher to a compact case.

14. The stretcher according to claim 2, further including means to transport said stretcher by aerial evacuation means.

15. The stretcher according to claim 3, further including means to transport said stretcher by aerial evacuation means.

16. The stretcher according to claim 4, further including means to transport said stretcher by aerial evacuation means.

17. The stretcher according to claim 5, further including means to transport said stretcher by aerial evacuation means.

18. The stretcher according to claim 6, further including means to transport said stretcher by aerial evacuation means.
